(19) United States
(12) Patent Application Publication
(10) Pub. No.: US 2006/0285611 A1
(43) Pub. Date: Dec. 21, 2006

(54) Method and radio receiver for increasing number of symbols used as pilot symbols in communication system

(75) Inventors: Pasi Kinnunen, Oulu (FI); Kari Horneman, Oulu (FI); Kari Pajukoski, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/210,787

(22) Filed: Aug. 25, 2005

(30) Foreign Application Priority Data
Jun. 15, 2005 (FI) 20055312

(51) Int. Cl. H04L 27/00

(52) U.S. Cl. 375/316

(57) ABSTRACT

A solution for determining in a radio receiver a data sequence indicating transmission parameters of a frame before the whole frame has been received in the radio receiver in order to obtain additional pilot symbols. According to the provided solution data is received in one or more time intervals, the data being part of a transmitted data sequence indicating transmission parameters of a frame. The possible data sequences are known to the radio receiver. The received data is compared with corresponding data of each known data sequence, and, based on the comparison, the data sequence which is determined to be closest to the received data is selected. The received data of the data sequence indicating the transmission parameters of the frame is then used as pilot data for channel estimation purposes, for example.

### FIELD

The invention relates to a solution for increasing the number of symbols used as pilot symbols in a communication system.

### BACKGROUND

In telecommunication systems, pilot symbols are used, for example, for signal-to-interference power ratio (SIR) estimation, channel estimation and synchronisation purposes. The pilot symbols are transmitted over a radio channel, and the pilot symbols are known to a receiver. In a frame-structured telecommunication system, each frame comprises a plurality of time intervals (or time slots), and each time interval comprises a plurality of pilot symbols and a plurality of data symbols. Other types of symbols may also be transmitted in one time interval.

As mentioned above, the pilot symbols are known to the receiver and, thus, the receiver may acquire knowledge of the radio channel by processing the pilot symbols. Usually there are, however, a limited number of pilot symbols available due to implementation reasons. The number of pilot symbols in a time slot depends on the time slot format. In the uplink of UMTS (Universal Mobile Communication System), for example, eight pilot symbols per time interval are available. In the downlink of UMTS, a maximum of 32 pilot symbols are available. Limitation of the number of available pilot symbols decreases the performance of the procedure the pilot symbols are used for.

### BRIEF DESCRIPTION OF THE INVENTION

An object of the invention is to provide a solution for determining in a radio receiver a data sequence indicating transmission parameters of a frame in order to obtain additional pilot symbols.

According to an aspect of the invention, there is provided a method for determining in a radio receiver a data sequence indicating transmission parameters of a frame, the data sequence being a data sequence of a data sequence set known to the radio receiver and the frame comprising a plurality of time intervals. The method comprises receiving data in one or more time intervals, the data being part of a transmitted data sequence indicating transmission parameters of a frame. The method further comprises comparing the received data with corresponding data of each known data sequence of the known data sequence set, selecting, on the basis of the comparison, the data sequence of the known data sequence set which is determined to be closest to the received data, and obtaining additional pilot data from the received data indicating the transmission parameters of the frame by removing data modulation from the received data indicating the transmission parameters of the frame by using the data of the selected data sequence of the known data sequence set.

According to another aspect of the invention, there is provided a radio receiver for determining a data sequence indicating transmission parameters of a frame, the data sequence being a data sequence of a data sequence set known to the radio receiver and the frame comprising a plurality of time intervals. The radio receiver comprises a communication interface for reception of data and a control unit being configured to receive, through the communication interface, data in one or more time intervals, the data being part of a transmitted data sequence indicating transmission parameters of a frame. The control unit is further configured to compare the received data with corresponding data of each known data sequence of the known data sequence set, select, on the basis of the comparison, the data sequence of the known data sequence set which is determined to be closest to the received data, and obtain additional pilot data from the received data indicating the transmission parameters of the frame by removing data modulation from the received data indicating the transmission parameters of the frame by using the data of the selected data sequence of the known data sequence set.

According to another aspect of the invention, there is provided a computer program product encoding a computer program of instructions for executing a computer process for determining in a radio receiver a data sequence indicating transmission parameters of a frame, the data sequence being a data sequence of a data sequence set known to the radio receiver and the frame comprising a plurality of time intervals. The process comprises receiving data in one or more time intervals, the data being part of a transmitted data sequence indicating transmission parameters of a frame. The process further comprises comparing the received data with corresponding data of each known data sequence of the known data sequence set, selecting, on the basis of the comparison, the data sequence of the known data sequence set which is determined to be closest to the received data, and obtaining additional pilot data from the received data indicating the transmission parameters of the frame by removing data modulation from the received data indicating the transmission parameters of the frame by using the data of the selected data sequence of the known data sequence set.

According to another aspect of the invention, there is provided a computer program distribution medium readable by a computer and encoding a computer program of instructions for executing a computer process for determining in a radio receiver a data sequence indicating transmission parameters of a frame, the data sequence being a data sequence of a data sequence set known to the radio receiver and the frame comprising a plurality of time intervals. The process comprises receiving data in one or more time intervals, the data being part of a transmitted data sequence indicating transmission parameters of a frame. The process further comprises comparing the received data with corresponding data of each known data sequence of the known data sequence set, selecting, on the basis of the comparison, the data sequence of the known data sequence set which is determined to be closest to the received data, and obtaining additional pilot data from the received data indicating the transmission parameters of the frame by removing data modulation from the received data indicating the transmission parameters of the frame by using the data of the selected data sequence of the known data sequence set.

An advantage the invention provides is an increased number of symbols which may be used as pilot symbols for channel estimation purposes, for example. The increased number of available pilot symbols increases the performance of the procedure the pilot symbols are used for. Additionally, no additional pilot symbols need to be transmitted by a transmitter.

### LIST OF DRAWINGS

In the following, the invention will be described in greater detail with reference to the embodiments and the accompanying drawings, in which

FIG. 1A illustrates a downlink frame structure of UMTS;

FIG. 1B illustrates an uplink frame structure of UMTS;

FIG. 2 illustrates a structure of a communication system in which embodiments of the invention may be implemented;

FIG. 3 illustrates a structure of a radio receiver in which embodiments of the invention may be implemented;

FIG. 4 illustrates a structure of a radio receiver according to an embodiment of the invention with main emphasis on the implementation of a channel estimator;

FIG. 5 is a flow diagram of a method of detecting a data sequence indicating transmission parameters of a frame according to an embodiment of the invention; and

FIG. 6 is another flow diagram of a method of detecting a data sequence indicating transmission parameters of a frame according to an embodiment of the invention.

### DESCRIPTION OF EMBODIMENTS

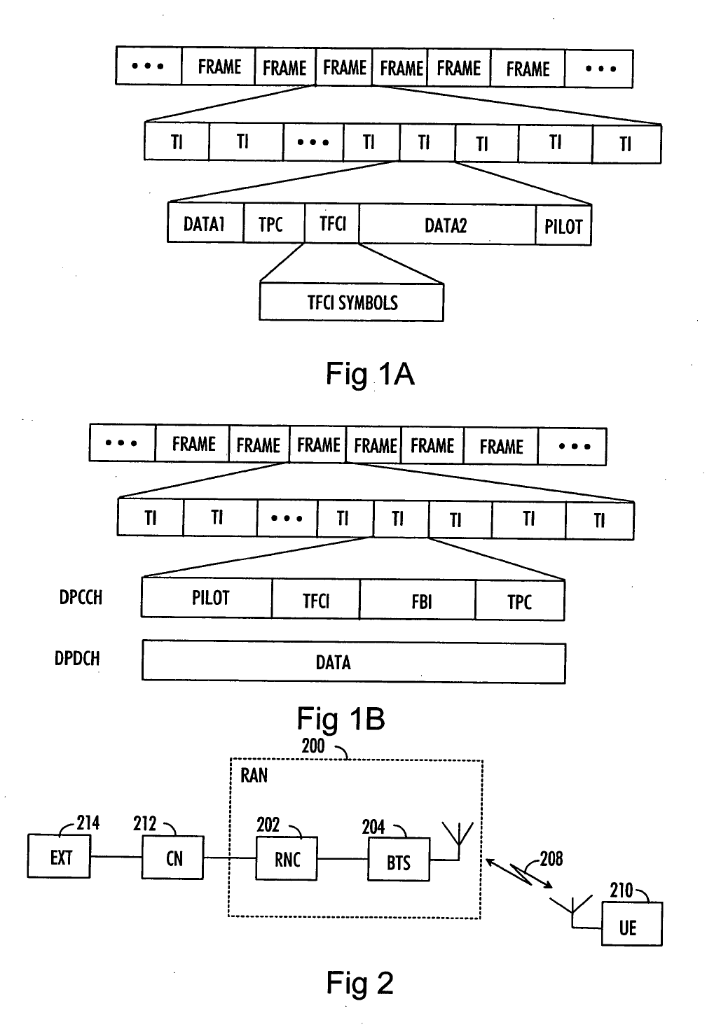

FIG. 1A illustrates a downlink frame structure of Universal Mobile Communications System (UMTS) according to the 3^{rd} Generation Partnership Project (3GPP) specifications. Each frame comprises a plurality of time intervals (or time slots), specifically 15 time intervals (TI). Each time interval comprises portions of data bits (DATA1 and DATA2), a portion of transmit power control bits (TPC), a portion of transport format combination indicator bits (TFCI), and a portion of pilot bits which may be used, for example, in channel synchronisation. FIG. 1B illustrates correspondingly an uplink frame structure of the UMTS. The uplink frame in FIG. 1B comprises data in data channel and TPC, TFCI, and pilot symbols. Additionally the uplink frame comprises feedback information (FBI) symbols.

The TFCI symbols are used for informing a receiver of transmission parameters of the frame. The TFCI symbols may comprise information on how to decode, demultiplex and deliver the received data on the appropriate transport channels. In UMTS, each TFCI word comprises 10 bits, and the TFCI bits are encoded by using a (32, 10) sub-code of the second order Reed-Muller code in a transmitter. Thus, the result of the encoding process is 32 encoded TFCI bits. In each time interval of a frame, two encoded TFCI bits are transmitted to a receiver. Since there are only 15 time intervals in the frame the last two TFCI bits may be set to zero and, thus, the receiver also knows that the last two bits, which were not transmitted, are zero. Prior to the transmission, the TFCI bits may be mapped (or modulated) into TFCI symbols according to a symbol constellation used in the transmission.

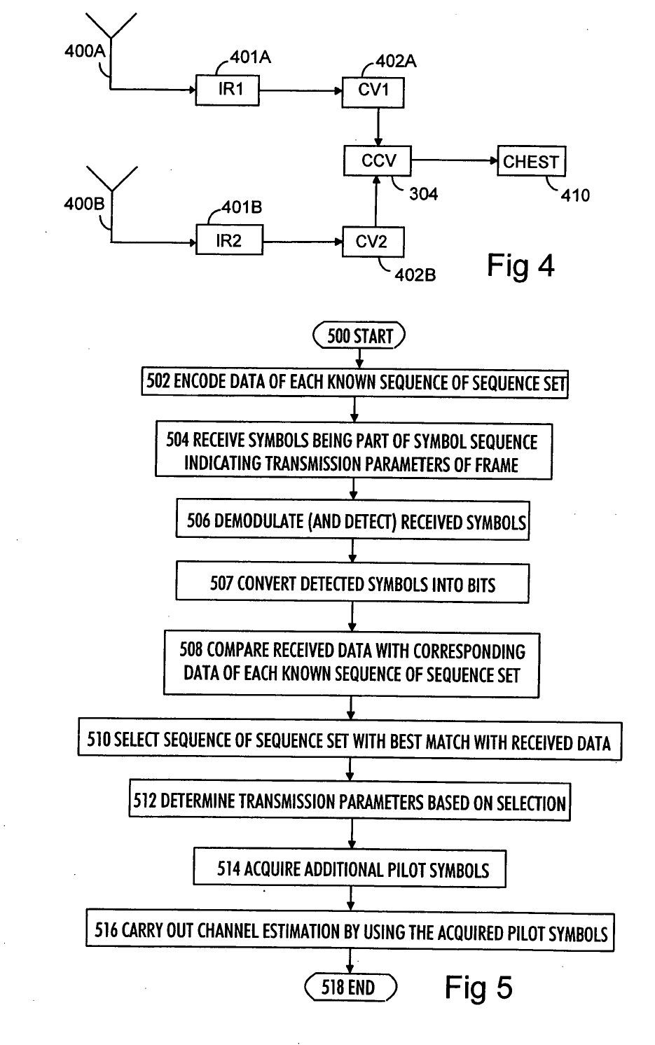

With reference to FIG. 2, examine an example of a data transmission system in which embodiments of the invention may be applied. The structure and the elements of the system illustrated in FIG. 2 are the same as in the Universal Mobile Telecommunication System (UMTS) network, but it should, however, be noted that implementation of the proposed data detection method is not limited to the UMTS system, but it may also be implemented in other suitable communication systems which employ frame-structured data transfer with each frame comprising a plurality of time intervals (or time slots), and a data sequence indicating transmission parameters of a frame being distributed over several time intervals.

The network elements of the communication system of FIG. 2 can be grouped into the radio access network (RAN) 200 that handles all radio-related functionalities of the system, and a core network (CN) 212, which takes care of switching and routing calls and data connections to external networks 214. External network may be for example the Internet, Integrated Services Digital Network (ISDN), or Public Switched Telephone Network (PSTN).

The radio access network 200 comprises one or several base transceiver stations (BTS) 204, or node Bs which is the equivalent term in the 3GPP specifications, and radio network controllers (RNC) 202. A BTS 204 is responsible for providing an air interface radio connection 208 to the subscriber units 210 within its coverage area also known as a cell. The BTS 204 also performs physical level signal processing like modulation, channel coding, etc. The BTS 204 may also perform some basic radio resource management operations like operations related to power control.

A radio network controller 202 is the network element which is responsible for the control of radio resources in the RAN 200. The RNC 202 serves as a switching and controlling element of the RAN 200 and typically controls several BTSs 204, but it may also control only a single BTS 204. RNC 202 is responsible for controlling load and congestion of traffic channels of its own cells. The RNC 202 also takes care of procedures related to admission control, handovers, and power control. The radio network controller 202 typically includes a digital signal processor and software for executing computer processes stored on a computer readable medium. Furthermore, the radio network controller 202 typically includes connecting means for communicating electric signals with other network elements, such as other radio network controllers and/or base transceiver stations, but also with the core network 212.

The core network 212 provides a combination of switching and transmission equipment, which together form a basis for telecommunication network services. The core network also performs procedures related to radio resource management. The core network 212 may provide circuit-switched and/or packet-switched data transport services to the user entities.

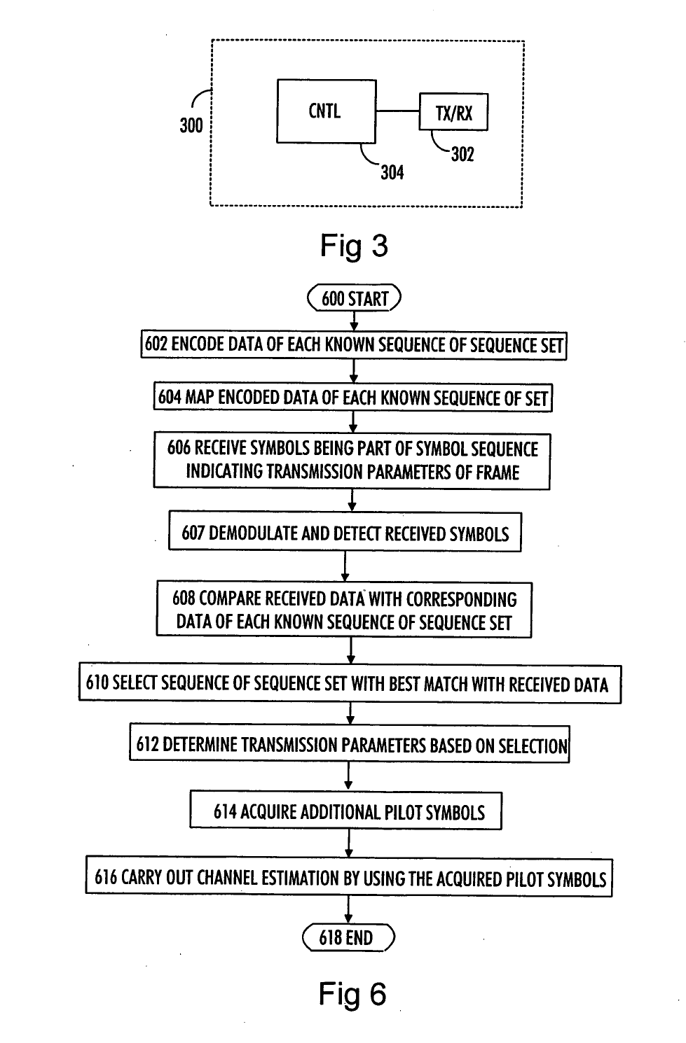

Next, structure of a radio receiver 300 will be described with reference to FIG. 3. The radio receiver 300 may be a subscriber unit of a communication system such as a mobile communication device, or a computer with a communication interface to provide a radio connection. The radio receiver may also be a network element of a communication system, such as a base transceiver station or an access point to a communication network.

The radio receiver 300 comprises a communication interface 302 to receive, in conjunction with an antenna, information signals transmitted over a radio connection. If the radio receiver 300 is a subscriber unit, the communication interface 302 may provide a connection with a communication network through a serving base transceiver station or an access point. The communication interface 302 may also provide capability to transmit information signals over a radio interface.

The radio receiver 300 further comprises a control unit 304 to control functions of the radio receiver 300. The control unit 304 may comprise means for retrieving information from a received signal. The retrieval procedure may comprise determining transmission parameters of a frame in reception from received data of a data sequence indicating the transmission parameters of the frame, and processing the frame in reception according to the determined transmission parameters. The control unit may also process received pilot symbols in order to estimate effects of a radio channel on the transmitted signal, for example. The control unit 304 may be implemented with a digital signal processor with suitable software embedded in a computer readable medium, or with separate logic circuits, for example with ASIC (Application Specific Integrated Circuit).

Next, determination of a data sequence describing transmission parameters of a frame is depicted with reference to the downlink in the UMTS. It should, however, be appreciated that the invention is not limited neither to the downlink direction nor to the UMTS and may be implemented in the uplink direction and in other communication systems as well.

During the establishment of a connection between a subscriber unit and radio network, a higher-level protocol may select a set of possible transport format combinations with each transport format combination being represented by a transport format combination indicator (TFCI) described in the Background section. This set may be referred to as a transport format combination set (TFCS). The TFCS may be transmitted to both the base station and the subscriber unit. Transmission parameters of frames used in communication between a subscriber unit and a base station may be selected by a medium access control (MAC) protocol located in a radio network controller. The transmission parameters are selected by selecting a TFCI associated with the desired transmission parameter from the TFCS. As mentioned above, the TFCI is a data sequence indicating the transmission parameters of a frame.

When communication between the base station and the subscriber unit is active, the base station receives data from the radio network controller to be transmitted to the subscriber unit. The base station processes the data according to parameters indicated by the TFCI currently in use. The TFCI indicates, among others, how to map transport channels which are used in communication between the base station and the radio network controller into dedicated channels which are used in communication with the base station and the subscriber unit and how to encode the data to be transmitted. After processing the data, the base station transmits the data to the subscriber unit in a frame-structured format.

The whole frame may be processed according to one TFCI and the TFCI corresponding to the frame is also transmitted to the subscriber unit such that the TFCI is distributed over the plurality of time intervals of the frame. Each time interval may comprise part of the TFCI sequence. The TFCI bits may be encoded in the transmitter (the base station in this example) using a determined coding scheme. The encoded TFCI bits may also be mapped and modulated into symbols according to a symbol constellation used in the transmission.

As mentioned above, the TFCS is also known to the receiver (subscriber unit in this example), and this information may be used in detection of the correct TFCI of a frame. When the receiver has received a determined amount of TFCI symbols, given by desired reliability of the detection, it may initiate a procedure for determining the transmitted TFCI. The desired reliability may be selected from a preset table. The more received TFCI symbols are included in the determination procedure, the more reliable the result.

For the detection of the TFCI of the frame, the receiver may first encode each TFCI sequence of the known TFCS using the same coding scheme as was used for the TFCI sequence of the frame in the transmitter. These encoded TFCI code words of the TFCS may be stored in the receiver such that there is no need to encode them at the reception of every frame.

At the reception of each time interval of the frame, the receiver may pick the TFCI symbols from the data of the time interval and demodulate, detect, and remove mapping of the TFCI symbols in order to obtain detected TFCI bits which are still in the encoded format. The demodulation, the detection, and the removal of mapping may be carried out using a procedure known in the art.

When a determined amount of detected TFCI bits have been obtained, the detected TFCI bits are compared with the corresponding TFCI bits of each encoded TFCI code word of the TFCS in the receiver. For example, if the first eight TFCI bits have been detected, these bits are compared with the first eight bits of each encoded TFCI code word of the TFCS. The comparison may be carried out using, for example, the following equation:

$$dist ( i ) = \frac{1}{{N}_{TFCI}} {\sum }_{n = 1}^{{N}_{TFCI}} \vert {TFCI}_{cw , i} ( n ) - {TFCI}_{rx} ( n ) \vert , \qquad ( 1 )$$

where dist(i) is the distance between the received detected TFCI bits and the TFCI bits of a TFCI code word of the TFCS, i is an index discriminating each TFCI of the TFCS (i runs from one to the number of TFCIs in the TFCS), NTFCI is the number TFCI bits included in the comparison, TFCI_{cw,i}(n) corresponds to the n^{th} TFCI bit of i^{th} TFCI code word of the TCFS, and TFCIᵣₓ(n) corresponds to the n^{th} TFCI bit of the received and detected part of the transmitted TFCI code word. As can be seen, equation (1) measures distance (or difference) between the received detected TFCI bits and the corresponding TFCI bits of each TFCI code word of the TFCS. Thus, after comparing each TFCI code word with the received detected TFCI bits, the TFCI code word with the lowest distance [dist(i)] to the received detected TFCI bits is selected, and transmission parameters of the frame are determined based on that selection. Now, that the transmission parameters of the frame have been determined, the receiver may start processing the data of the received time intervals by decoding, demultiplexing and delivering the received data on the appropriate transport channels before the whole frame has been received. When reception of a new frame is started, a new comparison between the newly received TFCI bits (which have been demodulated and detected) and the corresponding TFCI bits of each TFCI code word of the TFCS may be carried out.

Equation (1) may also be used, if each TFCI of the TFCS was not encoded in the receiver. In this case, the received detected TFCI bits may be decoded before the computation of the equation (1).

When comparing the received detected TFCI bits with each TFCI code word of the TFCS by using equation (1), two (or more) TFCI code words may have an equal distance dist(i) to the received TFCI bits. In this case, it may be determined that additional received TFCI bits has to be included in the comparison. Therefore, the receiver may wait for reception, demodulation and detection of additional TFCI bit or bits and recalculate distances with the additional TFCI bits. The distances may be calculated for those TFCI code words which were of equal distance to the received TFCI bits in order to reduce computational load, or the distances may be calculated for each TFCI code word of the TFCS. After the recalculation, the TFCI code word with the lowest distance [dist(i)] to the received detected TFCI bits is selected, and transmission parameters of the frame are determined on the basis of that selection.

According to another embodiment of the invention, detection of the transmitted TFCI code word may be carried out without a need to remove mapping of the received detected TFCI symbols. According to this embodiment, each known TFCI code word of the TFCS may be encoded by using a determined coding scheme and mapped according to the symbol constellation used in the transmission of the TFCI bits in the transmitter, yielding mapped TFCI bits for each TFCI code word of the TFCS.

Again, at the reception of each time interval of the frame, the receiver may pick the TFCI symbols from the data of the time interval, demodulate and detect them. When a determined amount of detected TFCI symbols have been obtained, the received detected TFCI symbols may be compared with the corresponding mapped bits of each TFCI code word by using the following equation:

$$dist 2 ( i ) = \frac{1}{{N}_{TFCIS}} {\sum }_{n = 1}^{{N}_{TFCIS}} {TFCI}_{cws , i} ( n ) {TFCI}_{rxs}^{*} ( n ) , \qquad ( 2 )$$

where dist2(i) is the result of the comparison between the received TFCI symbols and the mapped TFCI bits of a TFCI code word of the TFCS, i is an index discriminating each TFCI code word of the TFCS (i runs from one to the number of TFCI code words in the TFCS), N_{TFCIS} is the number of TFCI symbols included in the calculation of the equation (2), TFCI_{cws,i}(n) is the n^{th} mapped bit of the i^{th} TFCI code word of the TFCS, TFCI_{TXS}(n) is the n^{th} received TFCI symbol and * denotes a complex conjugate operation. As can be seen, equation (2) multiplies the complex conjugates of the received TFCI symbols with the corresponding mapped bits of the i^{th} TFCI code word and calculates an average value from these multiplications. Therefore, the TFCI code word which results in highest dist2(i) is selected as the most likely transmitted TFCI code word, and the transmission parameters of the frame are determined on the basis of that selection. Now, that the transmission parameters of the frame have been determined, the receiver may start processing the data of the received time intervals by decoding, demultiplexing and delivering the received data on the appropriate transport channels before the whole frame has been received.

In the above description, downlink case has been described. Naturally, the determination of transmission parameters of a frame according to the embodiments of the invention may be carried out in uplink case, too. In the uplink case, a base transceiver station, for example, may be the radio receiver performing the determination of the transmission parameters.

When the radio receiver has determined the transmitted TFCI code word, the receiver has knowledge of the transmitted TFCI bits. Thus, the receiver has knowledge of the TFCI bits which have not yet been received. Since the radio receiver has knowledge of the bit (and symbol) values of the TFCI symbols which have not yet been received, these TFCI symbols may then be used as additional pilot symbols for estimating properties of the radio channel through which the transmitted signal has propagated. The additional pilot symbols may also be used in channel estimation, signal-to-interference power ratio estimation, mobile terminal speed estimation, and/or synchronization, for example. The TFCI symbols already received may also be stored in the radio receiver such that they still include data modulation. These TFCI symbols may also be used as pilot symbols.

Next, an example of a channel estimation procedure, which may incorporate TFCI symbols as additional pilot symbols, is described with reference to FIG. 4. The channel estimation procedure of the following example is described referring to uplink direction, but it should be appreciated that the invention may also be implemented in the downlink direction. FIG. 4 illustrates a radio receiver according to an embodiment of the invention with main emphasis on the implementation of the channel estimator. A spread spectrum signal including user signals is received in a rake receiver via at least two receiving antennas 400A-400B. Impulse response of the user signal is formed in the means for synchronizing the user signal, for example periodically and in an antenna-specific manner in matched filters 401A-401B. Signals received via two or more antennas are preferably guided to the same channel estimator 410. The calculation means 402A-402B for correlation values form correlation values for delay components on the basis of the outputs of the matched filters. The calculation means utilize a certain number of impulse response measurements. If the number of measurements is 15, for example, a vector whose length is 15 is maintained in the calculation means. For example, at moment 15 correlation values [(1,15);(2,15); . . . (14,15)] are formed for the vector, when index 1 denotes a moment earlier than moment 15. At moment 16, the vector is moved forward by one step, and correlation values [(2,16);(3,16); . . . (15,16)] are formed. The rake receiver further comprises calculation means 404 for a combined correlation where correlation values based on signals received via different antennas are combined. A combined correlation value is formed for the above-mentioned moment 16, for example, the combined correlation being formed by means of the correlation value (3,16) of the first antenna and the corresponding correlation value (3,16) of the second antenna. Preferably the combined correlation value is formed as an average of individual correlation values. Processing continues this way until a combined correlation value vector has been formed which is in practice as long as the original correlation vectors.

Combined correlation values are preferably utilized in the channel estimator 410 in the receiver by evaluating how much pilot symbols correlate with each other. Based on this, the influence of channel distortion can be eliminated from the data parts of the received signal. The signal from which channel distortion has been eliminated is guided to further processing in the receiver, e.g. to channel decoding/deinterleaving means. By means of the method, the width of the Doppler spectrum can be found out with good accuracy, and the spectrum information can preferably also be utilized to find out the terminal speed. The speed can be determined by calculating Fourier transformation of the correlation function, for instance.

Next, there will be described a process for determining a data sequence indicating transmission parameters of a frame in reception in a radio receiver in order to obtain additional pilot symbols according to an embodiment of the invention with reference to a flow diagram of FIG. 5. The frame comprises a plurality of time intervals. The data sequence indicating the transmission parameters of the frame may be a TFCI of the UMTS and may be distributed over the plurality of time intervals in the frame. The data sequence is part of a data sequence of a data sequence set known to the radio receiver. The process starts in step 500.

In step 502, each data sequence of the data sequence set known to the radio receiver are encoded by using the same coding scheme used for encoding the data sequence indicating the transmission parameters of the frame in a transmitter. In step 504, data symbols being part of the symbol sequence indicating the transmission parameters of the frame are received in the radio receiver. In step 506, the received data symbols are demodulated and data detection is carried out to them. In step 507, the detected data symbols are converted into data bits. In step 508, the received detected data bits are compared with the corresponding data of each data sequence of the sequence set known to the receiver. The comparison may be carried out according to equation (1).

From step 508, the process moves to step 510 where the data sequence of the data sequence set which provides the best match with the received data is selected as the most likely transmitted data sequence indicating transmission parameters of the frame. From the selected data sequence indicating the transmission parameters of the frame, the transmission parameters of the frame are determined in step 512, and the data of the data sequence indicating the transmission parameters of the frame may be used as additional pilot data for estimating effects of a radio channel to the frame reception. The estimation may be a channel estimation procedure, for example. Conventional pilot data may be used, too. The data of the data sequence received before determination of the data sequence indicating the transmission parameters of the frame may be used as pilot data as well as the data of the data sequence being received after the determination of the data sequence indicating the transmission parameters of the frame. The additional pilot data is obtained in step 514, and the additional pilot data is used in carrying out channel estimation in step 516. The process ends in step 518.

Next, there will be described another process for determining a data sequence indicating transmission parameters of a frame in reception in a radio receiver in order to obtain additional pilot symbols according to an embodiment of the invention with reference to a flow diagram of FIG. 6. The frame comprises a plurality of time intervals. The data sequence indicating the transmission parameters of the frame may be a TFCI of the UMTS and may be distributed over the plurality of time intervals in the frame. The data sequence is part of a data sequence of a data sequence set known to the radio receiver. The process starts in step 600.

In step 602, each data sequence of the data sequence set known to the radio receiver are encoded by using the same coding scheme used for encoding the data sequence indicating the transmission parameters of the frame in a transmitter. In step 604, each encoded data sequence of the data sequence set known to the radio receiver are mapped into mapped bits by using the same symbol constellation as used for mapping the encoded data sequence indicating the transmission parameters of the frame in the transmitter.

In step 606, data symbols being part of the data symbol sequence indicating the transmission parameters of the frame are received in the radio receiver. In step 607, the received data symbols are demodulated and detected. In step 608, the received detected data symbols are compared with the corresponding mapped bits of each data sequence of the sequence set known to the receiver. The comparison may be carried out according to equation (2).

From step 608, the process moves to step 610 where the data sequence of the data sequence set which provides the best match with the received data is selected as the most likely transmitted data sequence indicating transmission parameters of the frame. From the selected data sequence indicating the transmission parameters of the frame, the transmission parameters of the frame are determined in step 612, and the data of the data sequence indicating the transmission parameters of the frame may be used as additional pilot data for estimating effects of a radio channel to the frame reception. The estimation may be a channel estimation procedure, for example. Conventional pilot data may be used, too. The data of the data sequence received before determination of the data sequence indicating the transmission parameters of the frame may be used as pilot data as well as the data of the data sequence being received after the determination of the data sequence indicating the transmission parameters of the frame. The additional pilot data is obtained in step 614, and the additional pilot data is used in carrying out channel estimation in step 616. The process ends in step 618.

The embodiments of the invention may be realized in an electronic device, comprising a communication interface and a control unit operationally connected to the communication interface. The control unit may be configured to perform at least some of the steps described in connection with at least one of the flowcharts of FIGS. 5 and 6. The embodiments may be implemented as a computer program comprising instructions for executing a computer process for detecting in a radio receiver a symbol sequence indicating transmission parameters of a frame, the symbol sequence being a symbol sequence of a symbol sequence set known to the radio receiver and the frame comprising a plurality of time intervals.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and/or a computer readable compressed software package.

Even though the invention has been described above with reference to an example according to the accompanying drawings, it is clear that the invention is not restricted thereto but it can be modified in several ways within the scope of the appended claims.

1. A method of determining in a radio receiver a data sequence indicating transmission parameters of a frame, the data sequence comprising a data sequence of a data sequence set known to the radio receiver and the frame comprising a plurality of time intervals, the method comprising:
receiving data in one or more time intervals, the data comprising part of a transmitted data sequence indicating transmission parameters of a frame;
comparing the received data with corresponding data of each known data sequence of the known data sequence set;
selecting, based on the comparison, the data sequence of the known data sequence set which is determined to be closest to the received data; and
obtaining additional pilot data from the received data indicating the transmission parameters of the frame by removing data modulation from the received data indicating the transmission parameters of the frame by using the data of the selected data sequence of the known data sequence set.

2. The method of claim 1, further comprising:
using the additional pilot data for estimating effects of a radio channel on a transmitted signal.

3. The method of claim 1, wherein the data sequence comprises a bit sequence, and the method further comprises:
encoding each bit sequence of a known bit sequence set with a same code used for encoding the bit sequence indicating the transmission parameters of the frame in a transmitter;
receiving encoded bits in one or more time intervals, the encoded bits comprising part of the encoded bit sequence indicating the transmission parameters of the frame; and
comparing the received encoded bits with corresponding bits of each known encoded bit sequence of the known bit sequence set.

4. The method of claim 3, wherein the comparing comprises comparing based on calculation of a difference between the received encoded bits with the corresponding bits of each known encoded bit sequence of the known bit sequence set.

5. The method of claim 4, wherein the comparing comprises comparing based on the following equation:
$$dist ( i ) = \frac{1}{{N}_{TFCI}} {\sum }_{n = 1}^{{N}_{TFCI}} \vert {TFCI}_{cw , i} ( n ) - {TFCI}_{rx} ( n ) \vert ,$$
where: dist(i) is the difference between the received encoded bits and the corresponding bits of an i^{th} known encoded bit sequence of the known bit sequence set,
N_{TFCI} is a number of received encoded bits included in the comparison,
TFCI_{cw,i}(n) corresponds to an n^{th} bit of the i^{th} known encoded bit sequence of the known bit sequence set, and
TFCI_{TX}(n) corresponds to the n^{th} bit of the received encoded bits of the encoded bit sequence indicating the transmission parameters of the frame.

6. The method of claim 1, wherein the data sequence comprises a bit sequence and the method further comprises:
encoding each bit sequence of a known bit sequence set with a same code used for encoding the bit sequence indicating the transmission parameters of the frame in a transmitter;
mapping each encoded bit sequence of the known bit sequence set into mapped bits by using a same symbol constellation used for mapping the bit sequence indicating the transmission parameters of the frame in the transmitter, to obtain mapped bits of each encoded bit sequence of the known bit sequence set;
receiving symbols in one or more time intervals, the symbols comprising part of a transmitted symbol sequence comprising indication of the transmission parameters of the frame;
detecting the received symbols; and
comparing the received symbols with a corresponding mapped bits of each encoded bit sequence of the known bit sequence set.

7. The method of claim 6, wherein the comparing comprises comparing based on the following equation:
$$dist 2 ( i ) = \frac{1}{{N}_{TFCIS}} {\sum }_{n = 1}^{{N}_{TFCIS}} {TFCI}_{cws , i} ( n ) {TFCI}_{rxs}^{*} ( n )$$
where: dist2(i) is a result of the comparison between the received symbols and the corresponding mapped bits of the i^{th} encoded bit sequence of the known bit sequence set,
N_{TFCIS} is a number of received symbols included in a calculation of the above equation,
TFCI_{cws,i}(n) is an n^{th} mapped bit of an i^{th} encoded bit sequence of the known bit sequence set,
TFCI_{TXS}(n) is the n^{th} received symbol, and
* denotes complex conjugate operation.

8. The method of claim 1, further comprising:
initiating the comparison upon reception of a determined amount of data of the data sequence indicating the transmission parameters of the frame.

9. The method of claim 8, further comprising:
indicating the transmission parameters of the frame based on a desired reliability of the detection using the determined amount of data of the data sequence.

10. The method of claim 1, further comprising:
determining, after the comparing, whether additional data indicating the transmission parameters of the frame is to be included in the comparison before selecting the data sequence of the known data sequence set closest to the received data;
receiving the additional indicating the transmission parameters of the frame, when determining that the additional data indicating the transmission parameters of the frame is to be included in the comparison; and
comparing the received data, including the additional data, with each known data sequence of the known data sequence set.

11. The method of claim 1, further comprising:
indicating the transmission parameters of the frame distributed over the time intervals of the frame using the data sequence.

12. The method of claim 1, further comprising:
determining transmission parameters of the frame before reception of the whole frame.

13. A radio receiver for determining a data sequence indicating transmission parameters of a frame, the data sequence comprising a data sequence of a data sequence set known to the radio receiver and the frame comprising a plurality of time intervals, the radio receiver comprising:
a communication interface for reception of data; and
a control unit being configured to
receive, through the communication interface, data in one or more time intervals, the data comprising part of a transmitted data sequence indicating transmission parameters of a frame,
compare the received data with corresponding data of each known data sequence of the known data sequence set,
select, based on the comparison, the data sequence of the known data sequence set which is determined to be closest to the received data, and
obtain additional pilot data from the received data indicating the transmission parameters of the frame by removing data modulation from the received data indicating the transmission parameters of the frame by using the data of the selected data sequence of the known data sequence set.

14. The radio receiver of claim 13, wherein the control unit is configured to use the additional pilot data for estimating effects of a radio channel on a transmitted signal.

15. The radio receiver of claim 13, wherein the data sequence comprises a bit sequence, and the control unit is further configured to
encode each bit sequence of a known bit sequence set with a same code used for encoding the bit sequence indicating the transmission parameters of the frame in the transmitter,
receive encoded bits of one or more time intervals, the encoded bits comprising part of the encoded bit sequence indicating the transmission parameters of the frame, and
compare the received encoded bits with corresponding bits of each known encoded bit sequence of the known bit sequence set.

16. The radio receiver of claim 15, wherein the control unit is configured to compare by calculating a difference between the received encoded bits with the corresponding bits of each known encoded bit sequence of the known bit sequence set.

17. The radio receiver of claim 16, wherein the control unit is configured to compare by calculating the following equation:
$$dist ( i ) = \frac{1}{{N}_{TFCI}} {\sum }_{n = 1}^{{N}_{TFCI}} \vert {TFCI}_{cw , i} ( n ) - {TFCI}_{rx} ( n ) \vert ,$$
where: dist(i) is the difference between the received encoded bits and the corresponding bits of an i^{th} known encoded bit sequence of the known bit sequence set,
N_{TFCI} is a number of received encoded bits included in the comparison,
TFCI_{cw,i}(n) corresponds to an n^{th} bit of the i^{th} known encoded bit sequence of the known bit sequence set, and
TFCI_{TX}(n) corresponds to the n^{th} bit of the received encoded bits of the encoded bit sequence indicating the transmission parameters of the frame.

18. The radio receiver of claim 13, wherein the data sequence comprises a bit sequence and the control unit is further configured to
encode each bit sequence of a known bit sequence set with a same code used for encoding the bit sequence indicating the transmission parameters of the frame in a transmitter;
map each encoded bit sequence of the known bit sequence set into mapped bits by using a same symbol constellation used for mapping the bit sequence indicating the transmission parameters of the frame in the transmitter, to obtain mapped bits of each encoded bit sequence of the known bit sequence set;
receive symbols in one or more time intervals, the symbols comprising part of a transmitted symbol sequence comprising indication of the transmission parameters of the frame;
detect the received symbols; and
compare the received symbols with corresponding mapped bits of each encoded bit sequence of the known bit sequence set.

19. The radio receiver of claim 18, wherein the control unit is configured to compare by calculating the following equation:
$$dist 2 ( i ) = \frac{1}{{N}_{TFCIS}} {\sum }_{n = 1}^{{N}_{TFCIS}} {TFCI}_{cws , i} ( n ) {TFCI}_{rxs}^{*} ( n )$$
where: dist2(i) is a result of the comparison between the received symbols and the corresponding mapped bits of an i^{th} encoded bit sequence of the known bit sequence set,
N_{TFCIS} is a number of received symbols included in a calculation of the above equation,
TFCI_{cws,i}(n) is an n^{th} mapped bit of the i^{th} encoded bit sequence of the known bit sequence set,
TFCI_{TXS}(n) is an n^{th} received symbol, and
* denotes complex conjugate operation.

20. The radio receiver of claim 13, wherein the control unit is further configured to initiate the comparison upon reception of a determined amount of data of the data sequence indicating the transmission parameters of the frame.

21. The radio receiver of claim 13, wherein the control unit is further configured to:
determine, after comparison, whether additional data indicating the transmission parameters of the frame is to be included in the comparison before selecting the data sequence of the known data sequence set closest to the received data;
receive through the communication interface, the additional data indicating the transmission parameters of the frame, when determining that more data indicating the transmission parameters of the frame is to be included in the comparison; and
compare the received data, including the additional data, with each known data sequence of the known data sequence set.

22. The radio receiver of claim 13, wherein the data sequence indicating the transmission parameters of the frame is distributed over the time intervals of the frame.

23. The radio receiver of claim 13, wherein the control unit is further configured to determine the transmission parameters of the frame before reception of the whole frame.

24. A radio receiver for determining a data sequence indicating transmission parameters of a frame, the data sequence comprising a data sequence of a data sequence set known to the radio receiver and the frame comprising a plurality of time intervals, the radio receiver comprising:
communication means for reception of data;
means for receiving, through the communication means, data in one or more time intervals, the data comprising part of a transmitted data sequence indicating transmission parameters of a frame;
means for comparing the received data with corresponding data of each known data sequence of the known data sequence set;
means for selecting, based on the comparison, the data sequence of the known data sequence set which is determined to be closest to the received data; and
means for obtaining additional pilot data from the received data indicating the transmission parameters of the frame by removing data modulation from the received data indicating the transmission parameters of the frame by using the data of the selected data sequence of the known data sequence set.

25. A computer program embodied in a computer-readable medium encoding instructions for executing a computer process for determining in a radio receiver a data sequence indicating transmission parameters of a frame, the data sequence comprising a data sequence of a data sequence set known to the radio receiver and the frame comprising a plurality of time intervals, the computer program perfoming a process comprising:
receiving data in one or more time intervals, the data comprising part of a transmitted data sequence indicating transmission parameters of a frame;
comparing the received data with corresponding data of each known data sequence of the known data sequence set;
selecting, based on the comparison, the data sequence of the known data sequence set which is determined to be closest to the received data; and
obtaining additional pilot data from the received data indicating the transmission parameters of the frame by removing data modulation from the received data indicating the transmission parameters of the frame by using the data of the selected data sequence of the known data sequence set.

26. A computer program distribution medium readable by a computer and encoding a computer program of instructions for executing a computer process for determining in a radio receiver a data sequence indicating transmission parameters of a frame, the data sequence comprising a data sequence of a data sequence set known to the radio receiver and the frame comprising a plurality of time intervals, the computer program performing a process comprising:
receiving data in one or more time intervals, the data comprising part of a transmitted data sequence indicating transmission parameters of a frame;
comparing the received data with corresponding data of each known data sequence of the known data sequence set;
selecting, based on the comparison, the data sequence of the known data sequence set which is determined to be closest to the received data; and
obtaining additional pilot data from the received data indicating the transmission parameters of the frame by removing data modulation from the received data indicating the transmission parameters of the frame by using the data of the selected data sequence of the known data sequence set.

27. The computer program distribution medium of claim 26, wherein the computer program distribution medium comprises at least one of the following mediums: a computer readable medium, a program storage medium, a record medium, a computer readable memory, a computer readable software distribution package, a computer readable signal, a computer readable telecommunications signal, and a computer readable compressed software package.
